(19) United States
(12) Patent Application Publication
(10) Pub. No.: US 2002/0178084 A1
(43) Pub. Date: Nov. 28, 2002

(54) Method and a system for identifying a medicine

(76) Inventor: Swi Barak, Caesarea (IL)

Correspondence Address: GREGORY L BRADLEY, MEDRAD INC, ONE MEDRAD DRIVE, INDIANOLA, PA, 15051

(21) Appl. No.: 10/109,564

(22) Filed: Mar. 28, 2002

(30) Foreign Application Priority Data
Mar. 29, 2001 (IL) 142326

(51) Int. Cl. G06F 17/60

(52) U.S. Cl. 705/26

(57) ABSTRACT

A system for encoding and decoding includes a code surface, a code reader and a controller. The code surface includes a non-conductive surface, divided into segments, and a number of conductive strips. Each strip is attached to and covers a segment of the non-conductive surface. The length of each strip represents a value, and a combination of values represents a code. The code reader includes a contacts-array divided into segments of contacts. The contacts-array is adapted to be attached to the code surface for reading the code. The controller is operable for recognizing the location of connected-contacts that match the conductive strips, calculating the length of strip of each segment, according to the number of the connected-contacts in a segment that are connected to the strips, and decoding the code according to a combination of the length of the strips.

### BACKGROUND OF THE INVENTION

The present invention relates to a method and a system for identifying a medicine. More specifically, the present invention relates to a method and a system for encoding labels and decoding the information from the label to identify a medicine in a package.

Labels are used to identify objects in the way of writing information on a label and attaching it to an object or in the way of encoding a label and storing information according to each code and retrieving the information by decoding the label code. Reliable identification is very important to ensure that the medical staff is using the right prescription medicine.

There are several methods and systems for encoding and decoding labels. The known methods need a specific label position to read the code from a label. One of the known methods is the barcode. When using the barcode method, the reader and the barcode must be aligned or a multi-position reader must be used, which is expensive and complicated.

There is therefore a recognized need for, and it would be highly advantageous to have, a new method and a system for identifying a medicine that enables using circular labels that can be read in any position.

### SUMMARY OF THE INVENTION

The present invention provides a method and a system for identifying a medicine by a unique way of encoding and decoding labels.

According to the teachings of the present invention there is provided a method for encoding and decoding including:

(a) encoding a code surface by attaching a number of conductive stripes on a non-conductive layer, wherein each strip partly covers a segment of the non-conductive layer, the length of each strip on each segment representing a value, and a combination of values representing a code;

(b) reading the code by attaching an array of contacts—divided into segments according to the code surface segments—to the code surface wherein the reading method comprises:

(i) the conductive strips make a common connection between some of the contacts that attach to the conductive strips while the rest of the contacts remain isolated (styled “isolated contacts” and “connected-contacts” ); and

(ii) the amount of said connected-contacts of each segment recognizes the length of each conductive strip; and

(c) decoding the code by recognizing a combination of values according to the length of the strips.

According to another aspect of the method of the present invention, the reading method comprises:

(i) the conductive strips make an electric connection with some of the contacts that attach to the conductive strips while the rest of the contacts remain isolated (styled “isolated contacts” and “connected-contacts” ); and

(ii) the conductive strips are connected to an electric power source and the electric power source is connected to the connected-contacts, sensing the electric power enables recognition of the connected-contacts.

By another aspect of the present method, the conductive strips start covering the segments in a common edge of the non-conductive layer.

By another aspect of the present method, the non-conductive layer is circular, the segments are circular and each of the conductive strips covers a sector of a segment.

By another aspect of the present method, in a circular form the conductive strips start covering the segments from a common radius.

By another aspect of the present method, the strips are non-conductive and the layer is conductive.

According to another aspect of the present invention, a system for encoding and decoding is provided, including:

(a) a code surface includes:

(i) a non-conductive surface, divided into segments; and

(ii) a number of conductive strips, each strip is attached and covers a sector of a segment of said non-conductive surface, wherein length of said strip represents a value and a combination of values represents a code;

(b) a code reader includes a contacts-array divided into segments of contacts, said contacts-array is used to attach the code surface for reading said code; and

(c) a controller operative for:

(i) recognizing the location of connected-contacts that match said conductive strips;

(ii) calculating the length of strip of each said segments, according to the number of said connected-contacts in a segment that connect to said strips; and

(iii) decoding said code according to a combination of said length of said strips.

According to another aspect of the present invention, the systems' recognition of the connected-contacts is based on the common connection of the connected-contacts, wherein the common connection is made via the conductive strips.

According to another aspect of the present invention, the systems' recognition of the connected-contacts is based on sensing an electric power. The conductive strips are connected to an electric power source and the recognition of the connected-contacts is based on the connection of the connected-contacts to the electric power via the strips.

According to a preferred embodiment, the system further includes a solar cell located on the code surface for supplying electric power. Also, the system further includes a light source located on the reader for activating the solar cell.

According to another preferred embodiment, the conductive strips start covering the segments in a common edge of the code surface.

According to another preferred embodiment, the code surface is a circular label including a non-conductive layer divided into circular segments and conductive strips that attach to a sector of segments, and the reader includes circular array of contacts divided to a segment according to the segments of the non-conductive layer.

By another preferred embodiment the strips start covering the segments in a common radius.

By another preferred embodiment the code surface further includes a conductive area in the center of the circular label, the conductive area is connected to the strips for supplying power to the strips and wherein the power is supplied via the center of the reader, enables recognition of the connected-contacts by sensing power. Moreover, the conductive area is connected to the strips by means of a thin conductor, the power burns the thin conductor in the first reading, which enables recognition of previous use.

By another aspect of the present invention, the code surface is made of a conductive surface and a non-conductive layer with holes, attached to the conductive surface, the arrangement of the holes represent a code and decoding is done by recognizing the location of the holes, which is the location of the connected-contacts that are connected with the conductive surface via the holes.

According to another aspect of the present invention, it is provided a system for reading information from a medicine package. The medicine package is held upside down, wherein the bottom portion is facing upright. The medicine package includes:

(a) a medicine package holder that holds the in-use medicine package;

(b) a circular label—divided into circular segments—that attach to the bottom of the in-use medicine package, the circular label made of a non-conductive layer and conductive strips covering a sector of each segment of the non-conductive surface, the length of the strips represent a code;

(c) a reader pivotally joined to the holder can rotate to attach the label, the reader made of a circular contacts array divided into segments according to the label segments; and

(d) a controller operative for:

(i) recognizing contacts of the circular contacts array that connected to the conductive strips;

(ii) calculating length of each strip according to the number of the connected-contacts; and

(iii) decoding the code according to the length of the strips.

By a preferred embodiment, the circular label further includes a conductive area in the center of the label, connected to the strips via a thin conductor. This thin conductor is burned in the first use by a power supplied by the reader, and the controller is further operative for recognizing previous use by checking for the existence of the thin conductor.

### BRIEF DESCRIPTION OF THE DRAWINGS

The invention is herein described, by way of example only, with reference to the accompanying drawings. With specific reference now to the drawings in detail, it is stressed that the particulars shown are by way of example aid for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates the method for encoding and decoding, according to the present invention;

FIG. 2 illustrates a circular label embodiment of the present invention with a circular reader; and

FIG. 3 illustrates a system for reading a code from a label of in-use medicine package;

### DESCRIPTION OF THE PREFERRED EMBODIMENTS

The present invention provides a method and a system for encoding and decoding.

The principles and operation of the encoding and decoding method and system, according to the present invention may be better understood with reference to the drawings and the accompanying description.

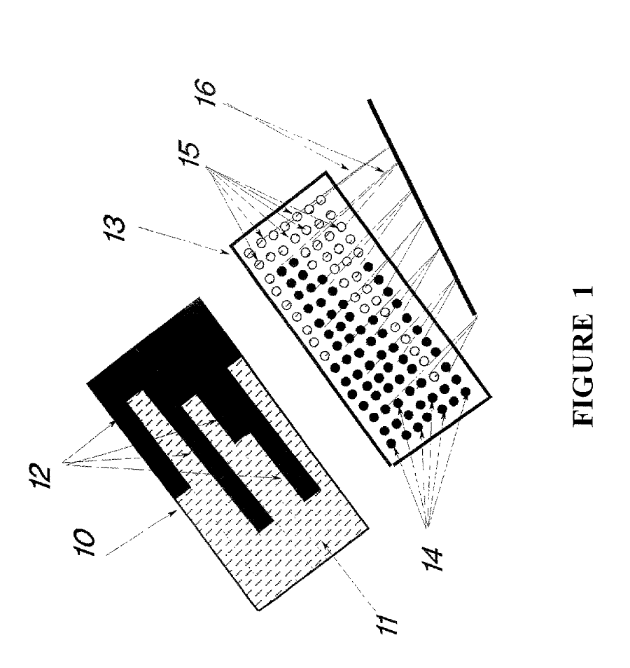

Referring now to the drawings, FIG. 1 illustrates a method for encoding and decoding, according to a preferred embodiment of the present invention. The code surface or a label 10 is made of a non-conductive surface or layer 11 and conductive strips 12 that attach to the non-conductive layer 11, each strip along a segment of the layer 11. The reader 13 is an array of electric contacts 14, each contact connected via a cable 16 to a controller (not shown). To read the code the reader 13 is attached to the label 10. The conductive strips 12 connect some of the contact 15 in a common connection, but the rest of the contacts—that are located in the area where the strips do not cover the segment—are isolated. The controller (not shown) recognizes the connected-contacts 15 either through the common connection of the connected-contacts 17, which is done by the conductive strips 12 or through sensing electric power that is supplied to the conductive strips 12. The controller (not shown) decodes the code according to a combination of strips length, which calculates according to the number of connected-contacts 15 of each segment.

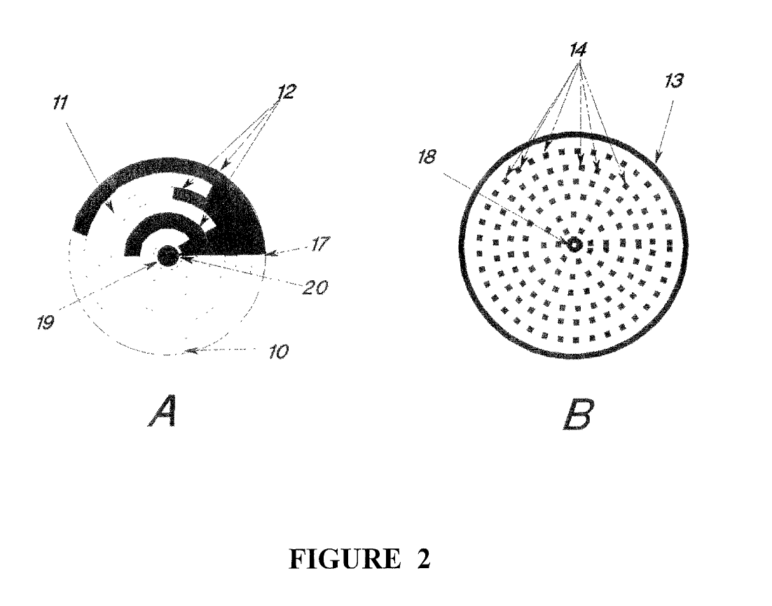

FIG. 2 illustrates a circular embodiment of the present invention with a circular reader. The label 10 is circular and is made of a circular non-conductive layer 11 divided to circular segments and conductive strips 12 that cover a sector of each segment, each strip 12 covers a sector of other segments with a different length. To read the code, the reader 13 is attached to the label 10 and the contacts array 14 is attached to the label 10, while part of the contacts are connected through the strips 12, the rest are isolated. In the figure, the strips start covering the segments in a common radius 17. The reader has a special contact 18 in the center that supplies power. The power is connected to the strips 12 via a conductive area 19 in the center of the label and through a thin conductor 20. The power is used for recognizing the connected-contacts when using the power sensing method of reading, and later to burn the thin conductor 20 and disconnect the conductive area 19 from strips 12. The disconnection is done in the first use and enables the controller (not shown) to recognize previous use of the label.

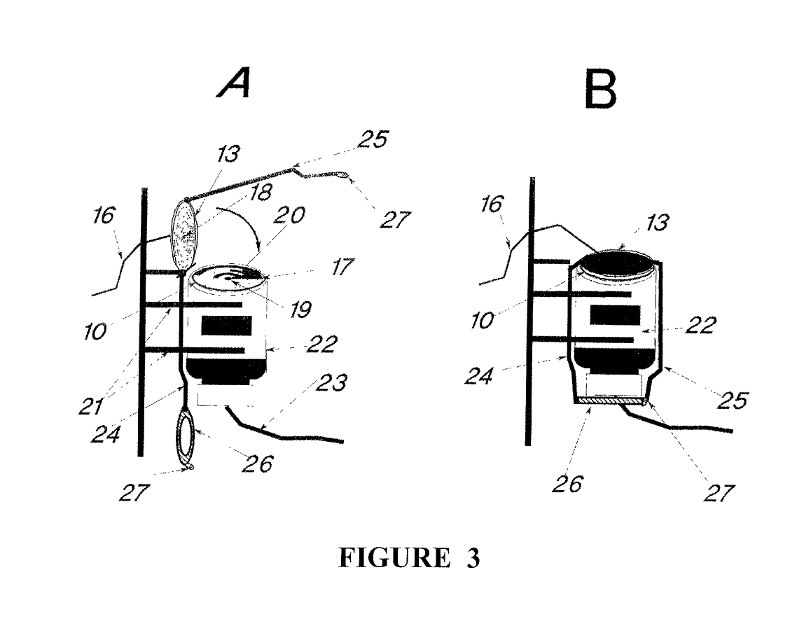

FIG. 3 illustrates a system for reading a code from a label that is attached on an in-use medicine package. FIG. 3A illustrates the system when the medicine package 22 is placed in the system and the package holder 21 is open. FIG. 3B illustrates the closed position of the system. In FIG. 3A, an in-use medicine package 22 is held, turned down, by a holder 21 for supplying the medicine via a pipe 23. The package holder has a first clamp 24 and a second clamp 25, a reader 13 pivotally joined between the clamps 24 and 25, a bottom holder 26 pivotally joined to the first clam 24 and two parts of fast locker 27 are connected to the bottom holder 26 and to the second clamp 25. To identify the in-use medicine package and its' contents, a circular label 10 is placed on its' bottom. A circular reader 13 pivotally joined with the holder clamps 24 and 25 enables the circular reader 13 to rotate for attaching to the circular label 10 when closing the clamps 24 and 25, as illustrated in FIG. 3B. The contacts of the reader 13 are connected via a cable 16 to a controller (not shown). A controller (not shown) identifies the connected-contacts of the reader 13 via a cable of wires 16. The controller (not shown) uses the common radius 17 as a reference, to locate the strips and their starting point. The controller calculates the length of each strip for decoding the code.

To prevent reuse of the same medicine package or at least to recognize previous use of the package, the system has the ability to recognize previous use. When the circular reader 13 is attached to the label 10, electric power supply through the special contact 18 to the conductive area 19 of the label 10. In the first time of reading, the conductive area 19 connected to the conductive strips 12 via a thin conductor 20. Electrical current, from the special contact 18 through the thin conductor 20 and back via the strips and the contacts, burns the thin conductor 20. In the later use, the controller recognizes the disconnection between the conductive area 19 and the strips 12 and acts as a predetermined action.

FIG. 3B illustrates the system when it is closed for use and the clamp 24 and 25 hold the medicine package 22. The second clamp 25 was rotated and the bottom holder 26 was rotated as well and locked by the fast locker 27 for clamping the medicine package 22. In this position the leader 13 is attached to the label 10 and the contacts information is transferred to the controller via the cable 16. The controller identifies the medicine package 22 and checks for previous use by checking the existence of the thin conductor 20. The information can display or transfer to any other device or controller.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for encoding and decoding comprising:
encoding a code surface by attaching a number of conductive strips on a non-conductive layer, wherein each strip partly covers a segment of said non-conductive layer, the length of each of said strip on said segment represents a value and a combination of said values represent a code;
reading said code by attaching an array of contacts—divided into segments according to said code surface segments—to said code surface, wherein the reading method comprises:
said conductive strips make a common connection between some of said contacts that attach to said conductive strips while the rest of said contacts remain isolated (styled “isolated contacts” and “connected-contacts”); and
said common connection of said connected-contacts of each segment recognizes the length of said conductive strip; and
decoding said code by recognizing said combination of values according to the length of said strips.

2. The method for encoding and decoding of claim 1 wherein said reading method comprises:
said conductive strips make an electric connection with some of said contacts that attach to said conductive strips while the rest of said contacts remain isolated (styled “isolated contacts” and “connected-contacts”); and
said conductive strips are connected to an electric power and said electric power connected to said connected-contacts and said electric power enables recognition of said connected-contacts.

3. The method for encoding and decoding of claim 1 wherein said conductive strips start covering said segments in a common edge of said non-conductive layer.

4. The method for encoding and decoding of claim 1 wherein said non-conductive layer is circular, said segments are circular and each of said conductive strip covers a sector of a segment.

5. The method for encoding and decoding of claim 4 wherein said conductive strips cover said sectors from a common radius.

6. The method for encoding and decoding of claim 1 wherein said strips are non-conductive and said layer is conductive.

7. A system for encoding and decoding comprising:
a code surface comprising:
a non-conductive surface, divided into segments; and
a number of conductive strips, each strip is attached and covers a segment of said non-conductive surface, wherein the length of said strip represents a value and a combination of values represents a code;
a code reader comprising a contacts-array divided into segments of contacts, said contacts-array is to be attached to the code surface for reading said code; and
a controller operative for:
recognizing the location of connected-contacts that match said conductive strips;
calculating the length of strip of each said segments, according to the number of said connected-contacts in a segment that are connected to said strips; and
decoding said code according to a combination of said length of said strips.

8. The system of claim 7 wherein the recognition of said connected-contacts is based on the common connection of said connected-contacts, said common connection is made via said conductive strips.

9. The system of claim 7 wherein said conductive strips are connected to an electric power source and the recognition of said connected-contacts is based on the connection of said connected-contacts to said power source via said strips.

10. The system of claim 7, further comprising a solar cell located on said code surface for supplying said electric power and a light source located on said reader for activating said solar cell.

11. The system of claim 7 wherein said conductive strips start covering said segments in a common edge of said code surface.

12. The system of claim 7 wherein said code surface comprises a circular label comprising a non-conductive layer divided into circular segments and conductive strips that attach to said segments, and said reader includes circular array of contacts divided into segments according to said segments of said non-conductive layer.

13. The system of claim 12 wherein said strips start covering said segments in a common radius.

14. The system of claim 12 wherein said code surface further comprises a conductive area in the center of said circular label, said conductive area is connected to said strips for supplying power to said strips and wherein said power is supplied via the center of said reader, which enables recognizing said connected-contacts by sensing power.

15. The system of claim 14 wherein said conductive area is connected to said strips by means of a thin conductor, and wherein said power burns said thin conductor in the first reading, which thereby enables recognition of previous use.

16. The system of claim 7 wherein said code surface comprises a conductive surface and a non-conductive layer with holes attached to said conductive surface, arrangement of said holes represent a code and decoding is done by recognizing the location of said connected-contacts according to a connection with said conductive surface via said holes and recognizing said arrangement.

17. A system for reading information from an in-use medicine package by reading a label located in the bottom of said in-use medicine package, the system comprising:
a medicine package holder that holds said in-use medicine package turned upside down;
a circular label—divided into circular segments—that attach to the bottom of said in-use medicine package, said circular label comprising a non-conductive layer and conductive strips covering segments of said non-conductive surface, the length of said strips representing a code;
a reader, pivotally joined to said holder, that rotates and attach to said label, said reader comprised of circular contacts array divided into segments according to said label segments; and
a controller operative for:
recognizing contacts of said circular contacts array that are connected to said conductive strips;
calculating the length of each strip according to the number of said connected-contacts; and
decoding said code according to the length of said strips.

18. The system of claim 17 wherein said circular label further comprises a conductive area in the center of said label, connected to said strips via a thin conductor, said thin conductor is burned in the first use by a power that supplied by the reader, and said controller is further operative for recognizing previous use of said medicine package by checking the existence of said thin conductor.
